(19) United States
(12) Patent Application Publication
(10) Pub. No.: US 2013/0145024 A1
(43) Pub. Date: Jun. 6, 2013

(54) METHOD AND APPARATUS FOR TRANSFER OF RADIO RESOURCE ALLOCATION

(71) Applicants: Happia Cao, Beijing (CN); Jilei Tian, Beijing (CN); Jesper Olsen, Beijing (CN); Pekka Ketola, Tampere (FI); Satu Kalliokulju, Vesilahti (FI)

(72) Inventors: Happia Cao, Beijing (CN); Jilei Tian, Beijing (CN); Jesper Olsen, Beijing (CN); Pekka Ketola, Tampere (FI); Satu Kalliokulju, Vesilahti (FI)

(73) Assignee: NOKIA CORPORATION, Espoo (FI)

(21) Appl. No.: 13/817,065

(22) PCT Filed: Aug. 16, 2010
(86) PCT No.: PCT/CN10/76015

§ 371 Date: Feb. 14, 2013

(51) Int. Cl. H04L 29/08

(52) U.S. Cl. CPC H04L 67/22
USPC 709/224

(57) ABSTRACT

An approach is provided for initiating a device action in response to determining context information associated with a device, a user of the device, or a combination thereof. Activity information on at least one of the device and one or more other devices is monitored by a context processing platform. The context processing platform defines a context based on the activity information. An action is then executed by the device or the one or more other devices based on the determined context.

### BACKGROUND

Today's Internet ready wireless communication devices, such as mobile phones, personal data assistants (PDAs) and the like, make on-demand access to information very convenient for device users. For example, when a user plans a trip, purchase, meeting, adventure or any other activity, it is a common and frequent behavior for them to seek information about the impending activity beforehand from the Internet. Internet based search tools available on devices provide users with access to a wealth of information, articles, documents, product specifications, user reviews and other useful data regarding their intended activity from a multitude of online sources. Generally, these sources vary in terms of their usefulness or relevancy, but are nonetheless helpful in providing details about the activity in advance. While having advance access to this information from the wireless communication device is useful for planning the activity, the user has no convenient way to readily recall the information within the context of present moment engagement of the activity.

Recalling prior discovered search information in response to present moment device usage or user activity is only one example of how to trigger device actions given a determined context. Another example is the triggering of reminders or other device actions based on perceived location information, wherein context recognition is performed based on current device traveling mode, application usage, mood and so on. Unfortunately, most reminder applications are based on a time or location-based trigger at best, but do not account for other contextual information available with respect to the activity in question. Furthermore, most reminder applications are limited to execution with respect to the originating user's device and cannot be defined and shared with respect to other device users.

### SOME EXAMPLE EMBODIMENTS

Therefore, there is a need for an approach to initiating a device action in response to determining context information associated with a device, a user of the device, or a combination thereof.

According to one embodiment, a method comprises determining to monitor user activity information on at least one of the device and one or more other devices. The method also comprises determining to define a context, an event, or the combination thereof based, at least in part, on the user activity information. The method further comprises determining to associate an action with the context, the event, or the combination thereof.

According to another embodiment, an apparatus comprising at least one processor, and at least one memory including computer program code, the at least one memory and the computer program code configured to, with the at least one processor, cause, at least in part, the apparatus to monitor user activity information on at least one of the device and one or more other devices. The apparatus is also caused to determine to define a context, an event, or the combination thereof based, at least in part, on the user activity information. The apparatus is further caused to determine to associate an action with the context, the event, or the combination thereof.

According to another embodiment, a computer-readable storage medium carrying one or more sequences of one or more instructions which, when executed by one or more processors, cause, at least in part, an apparatus to monitor user activity information on at least one of the device and one or more other devices. The apparatus is also caused to determine to define a context, an event, or the combination thereof based, at least in part, on the user activity information. The apparatus is further caused to associate an action with the context, the event, or the combination thereof.

According to another embodiment, an apparatus comprises means for determining to monitor user activity information on at least one of the device and one or more other devices. The apparatus also comprises means for determining to define a context, an event, or the combination thereof based, at least in part, on the user activity information. The apparatus further comprises means for determining to associate an action with the context, the event, or the combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system for initiating a device action in response to determining context information associated with a device, a user of a device, or a combination thereof, according to one embodiment;

FIG. 2 is a diagram of a context processing platform, according to one embodiment;

FIGS. 3A and 3B are flowcharts of a process for determining context information associated with a device, a user of a device, or a combination thereof, according to one embodiment;

FIG. 4 is a flowchart of a process for determining to initiate an action corresponding to a determined context, event or combination thereof, according to one embodiment;

FIGS. 5A and 5B are flowcharts of a process for associating a context, event and corresponding context criteria with one or more devices for enabling a device action, according to one embodiment;

FIGS. 6A and 6B are diagrams of interactions between a client and a server utilized in the data exchange process as included in the processes of FIGS. 3A, 3B, 4, 5A and 5B, according to various embodiments;

FIGS. 7A-7H are diagrams of user interfaces of a device utilized in the processes of FIGS. 3A, 3B, 4, 5A and 5B, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for initiating a device action in response to determining context information associated with a device, a user of the device, or a combination thereof are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form to avoid unnecessarily obscuring the embodiments of the invention. Although various embodiments are described with respect to a mobile device, it is contemplated that the approach described herein may be used with any other device that renders information to a user by way of a display mechanism.

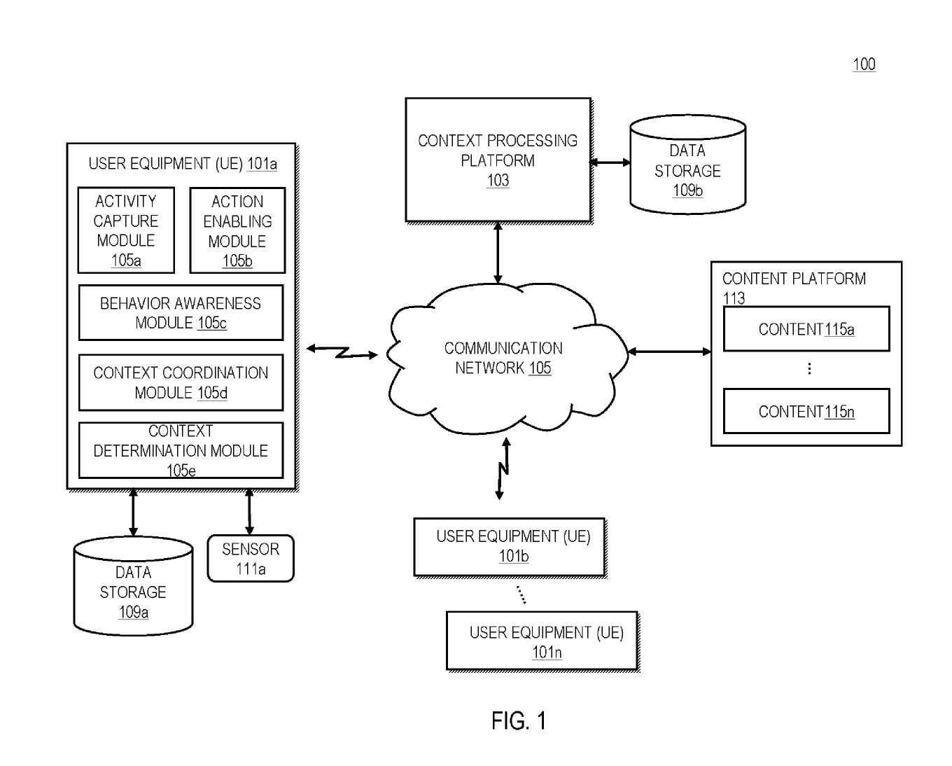

FIG. 1 is a diagram of a system for initiating a device action in response to determining context information associated with a device, a user of a device, or a combination thereof, according to one embodiment. By way of example, the action to be executed may be a response to determined context and/or activity information for a device user and their respective device 101a, or various other users and their respective devices 101b-101n. It is noted that how a person uses a device (e.g., a mobile device) can be examined to show specific patterns that represent that user's behaviors or tendencies relative to a given context. By way of example, some mobile devices 101a keep records of a user's interactions with their device, such as when the user engages the device for: (1) communicating via text messaging or e-mail (e.g. through maintenance of a communication log/history); (2) playing media files or streaming data; (3) social networking; (4) using certain applications; etc. Data is recorded, therefore, as activity information, which pertains to any data indicative of the current activity the user is engaged in with respect to the device.

Activity information, however useful, does not generally reveal much else about the device user aside from how they may be using certain applications and features of the device or what they're using it for. When the user's activities are considered in light of context information, which includes information indicative of the time, device or user location, environmental conditions relative to the device or user, etc., a context for the device and/or device user may be ascertained (e.g., user is riding a train).

In general, context information refers to, at least in part, all contextual data, user data and user-to-device interaction data (e.g., date, time of day, location, activity, motion, position, modality, spatiotemporal element, etc.) as collected, and is particularly useful for determining a present state or modality of the device. In addition, context information can be determined through analysis of historical data pertaining to the user or device, so as to enable a means of predicting to a degree to certainty expected or future device states or modalities. For example, if it is observed that a user frequently executes a music player during the early morning hours of the day, this information can be utilized for determining or defining a context relative to the user based on this tendency (e.g., context=workout time). Hence, the compilation of context information can be analyzed appropriately, including referenced with respect to additional data and/or a context model, for enabling the context of a device, device user or one or more other associated users and their respective devices to be determined accordingly.

By way of example, context information may include data transmitted during an instance of device engagement with a content platform 113 for accessing various types of content 115a-115n as provided by one or more content or service providers configured to the communication network 105. Content provided by respective content or service providers via the content platform 113 may include, but is not limited to, weather data, location information, mapping data, media content, web feed data, user profile information, markup language and text, scripts, graphical content, augmented reality data, webservices, etc. Also, by way of example, context information may pertain to any data gathered by one or more sensors 111a of the device, said data representing sensory phenomena useful for characterizing the present moment interaction between the device and one or more devices, objects or users. Objects for which the device may interact may include, but is not limited to, other user devices (e.g., cell phones), peripheral devices such as Bluetooth headsets, keyboards and server devices or entities within the immediate environment or context of use such as buildings, landmarks, machines, vehicles or people.

In general, context information can be defined as a data type conforming to one or more contexts, wherein each context is defined according to a context model or template. For example, given context information received as data types including a time, context data, and interaction data, e.g., [time=t1, Context Data=<(Work Day), (Evening), (High Speed), (High Audio Level)>, Interaction=Play Games], various combinations or permutations of the context data can yield various contexts such as: (1)<(Evening)>, (2)<High Speed>, (3)<(Work Day), (Evening)>, etc. It is contemplated that context information can be any subset of data types arranged in any combination, defined in accord with a context model.

It is noted that because the context involving the mobile device is often closely associated with specific usage intent, associations between specific contexts and the user interactions with the device may characterize the user's behavior patterns. This characterization is defined according to the context model. As used herein, a “context model” pertains to any data type definitions, associated data structures and/or schema for representing an object, interaction, event, process or combination thereof. In particular, the context model indicates the classifier types, identifiers and object types, associated expected input data types and the expected response or output data types for the context being modeled (e.g., a system, an event or object based context). Furthermore, the context model indicates the relationships between the data sets and data types of which it is comprised. Still further, the context model may also define one or more object-oriented, abstract or conceptual elements that in combination, characterize the behavior of an underlying system, object, interaction, event or process. It is noted that the various known approaches to generation of a context model are within the scope of the embodiments as presented. As a general approach, the context model can be designed and trained initially through various techniques to pattern known or historical interactions respective to a device, object or user.

Recognizing the context information pertaining to a given context model can enable automation of various interactions between the mobile device and the user, event or object associated with the context. For example, given a perceived real-world context that the user is waiting for a bus in the evening after a work period and a current activity is the user is reviewing a music playlist, the expected (typical) behavior pattern (e.g., derived from the user's previously recorded interaction history) is that the user plays the music with a maximum sound level by way of a audio player application resident on or accessible by the device. Consequently, the context model for this context and interactivity is designed with inputs and outputs corresponding to this scenario. In another example, given a context that the user is taking a bus in the morning of a work day, while engaged with a word processing application of the device, the expected behavior pattern is that the user opens specific files related to their work tasks. Again, the context model for this context and interactivity is designed with inputs and outputs corresponding to this scenario. As before, the context model characterizing this interaction and context is based in part on historical or expected data and patterns and/or present moment phenomena, enabling deterministic behavior to be determined for the user and/or device.

In certain instances, historic information can prove useful for enhancing a user's experience with their device respective to a determined device and/or user context, particularly for enabling training of a context model and subsequently for better establishing automation of certain device actions. For example, when a user performs an online information search from their device, the search will return content 115a-115n pertaining to their search topic. In instances when the search topic pertains to a future activity, such as a trip, purchase, meeting, personal interaction, etc. the user plans to engage, the results may need to be recalled at a later time—i.e., within the context of the user engaging in the actual activity. Unfortunately, current approaches to recalling the historical search results relative to a present moment context or user activity, at best, requires the user to open an ad-hoc data file containing the content 115a-115n, i.e., a text file. Alternatively, the user is forced to perform the search all over again at that very moment.

As another example, another useful device action that may be desired by a user is the automated execution of reminders, alerts and other prompts relative to a determined user and/or device context. Unfortunately, most reminder applications are triggered based on a time, such as when the user sets the reminder to occur according to an alarm or calendar function. Alternatively, a location-based trigger may be employed, such as when the device is conditioned to invoke a reminder according to a certain location being detected by the device (e.g., via global positioning system data). Neither approach accounts for the full range of contextual and activity information available with respect to the user or device, such as to enable personalized reminders to be executed at precise moments and/or sequences of activity and context engagement. Furthermore, most reminder applications are limited to execution with respect to a single device, namely the device of the user, and hence limited to fulfillment of the trigger conditions by way of only that device. Automatic invocation of a reminder or other action by the interested user's device based on the probability of fulfillment of a context or activity based trigger condition as set for their device or that of others, is not a reality in today's marketplace.

To address this issue, system 100 of FIG. 1 enables a device to associate and recall prior collected activity information (e.g., content 115a-115n from a search result) with present moment context or activity information. Still further, the system 100 facilitates execution of a reminder or other action within a user device or that of others based, at least in part, on the current context or activity information. The system 100 comprises user equipment (UE) 101 having connectivity to a context processing platform 103 via a communication network 105. In the example of FIG. 1, the context processing platform 103 collects activity information as recorded or monitored by the one or more UE 101a-101n. The platform 103 also analyzes the activity information with respect to determined context information pertaining to the device, user, other devices or other users, to perform one or more of the following: 1) determine if a particular activity associated with the device and the device user pertains to a specific device or user context; 2) compile recorded activity and perceived context information correlating to a specified context model; 3) provide information to the user device for enabling it to automatically invoke device actions based on determination of fulfillment of a particular context.

In certain embodiments, the UE 101 may include various executable modules 105a-105e for interacting with the context processing platform 103, as well as perform one or more useful device actions relative to the context processing functions of the context processing platform 103. While not shown expressly, each of the one or more UE 101a-101n may be configured in the same fashion or alternatively, feature only some of the exemplary modules 105a-105d if any. The exemplary modules of the UE 101a include, according to an exemplary embodiment, an activity capture module 105a for recording, logging and/or monitoring the various activities and interactions of the user equipment 101 with respect to the user. When a user employs the various software applications of the UE 101, as featured on many computer-oriented devices today, the activity capture module 105a records the inputs provided by the user during interaction with said applications as well as records the various outputs produced by the application where applicable. The data as recorded is maintained as activity information, and subsequently shared for compilation by the context processing platform 103. For example, when operating an internet based search tool (not shown), the activity capture module records the search criteria as input by the user. In addition, any content 115 returned as a search result is also stored and maintained as activity information. Still further, the activity capture module 105a monitors the types of interaction engaged by the user with the content, such as noting bookmarked information, noting the amount of site revisits for specific content, the amount of time a user actively engaged a particular site, etc. As another example, when operating a voice recorder tool, the activity capture module 105a maintains the recorded sound content as activity information.

An exemplary execution of the activity capture module 105a is presented below:

Start the activity capture process upon execution of a search tool, intelligent information system, data acquisition tool, digital recorder or any other utility for enabling the input of data potentially descriptive of topical data or the subject matter. In certain embodiments, the various applications for which the activity capture module 105a may be aligned can be specified in advance by the user of the device.

Record the user input (text, audio, image, gestures, etc.) as provided to the respective application (e.g., the search terms input into a search tool).

Record the results generated that the user applies and uses (reads, saves, bookmarks keeps open, etc.). While a user may generate numerous results or application outcomes, only those which are indicative of the most user interaction provide valuable activity information.

When the continuous user activity ends, compile the input and results to an activity file labeled based on the most frequent word contained within the data set. A context model may be employed for organizing the data according to a specific schema or data structure. For example, if the search was performed against the search term “Judo techniques,” the result set would contain similar expressions, phrases and words pertaining to this subject matter. Consequently, the activity file may be saved as “Judo” and appended with the appropriate data format nomenclature (e.g., *.txt, *.xml).

Transmit and/or upload the file to the context processing platform 103.

Update the event file when new related activity as engaged by the user and/or user device, i.e., pertaining to “Judo techniques,” is identified.

In one sample use case, a user browses the Internet at 3 pm at the user's home to search for the words “hotels,” “St. Petersburg,” and “August 2010.” The user also browses in detail a “Hotel Kempinski” based on the results of the browsing. Using the process described above, the activity capture module 105a can evaluate the user's browser history and search trail (e.g., as captured by the user's browser application) to determine (e.g., by using a semantic analysis or a semantic model) that the words searched by the user indicate a potential activity. In this example, the potential activity is a trip to St. Petersburg, Russia. Accordingly, the context processing platform 103 can determine the information and/or meta-data relating to this potential activity. For example, the platform 103 identifies and stores the following pieces of information: (1) “The user is looking for accommodations in St. Petersburg in August 2010; (2) “The user prefers the Hotel Kempinski”; (3) “The user is/may be planning a trip to Russia”; and (4) “The user may need to also consider visa and transportation requirements.” This information can then be used in the processes described below.

In addition to capturing activity information, an exemplary embodiment features a behavior awareness module 105c for monitoring or recording context information associated with a user, UE 101a or other UEs 101b-101n. The data as recorded is maintained as context information, and subsequently shared with the context processing platform 103 for compilation. By compiling the activity information and context information, the context processing platform 103 can analyze the data to formulate a prediction regarding user activities, and furthermore inform the UE 101 of a potential context associated with a currently monitored activity associated with the user or the device. For example, consider an internet search scenario wherein activity information pertaining to “Judo techniques” is consistently compiled, and context information such as a map relating the location of a Martial Arts school is identified as a recent addition to the dataset. The context processing platform 103 can formulate a reasonable estimation or prediction of the context based on analysis and other data points, to be: “Judo techniques to practice at school.” In this example, the activity=Judo, while the context pertains to the location of the school. Further observation of activity or context information by the context processing platform 103, including details regarding the users frequency of interaction with various content, people, activities, or the like can render further intelligence regarding the particular school, it's familiarity to the user (e.g., is this a visiting school or the user's home school), typical times of attendance for the user, etc.

As mentioned before, context information can be defined based on historical data (modeling techniques), or in other instances include contextual data, user data, user-to-device data, user-to-user interaction data, etc. In other instances, the context information can be defined manually by a user. Still further, the behavior awareness module 105c can interact with and control one or more sensors 111, wherein the control is facilitated with respect to a particular user defined context model. So, for example, in generating the context model intended to represent or characterize a particular context, one or more sensors 111 may be specified to provide input data corresponding to defined input data types. Exemplary sensors 111 may include, but is not limited to, a sound recorder, light sensor, global positioning system (GPS) and/or spatio-temporal detector, temperature sensor, motion sensor, accelerometer, gyroscope and/or any other device for perceiving sensory and environmental phenomena. The sensors 111 may also include an internal antenna through which wireless communication signal data may be detected. Upon receipt or detection, the UE 101 can then store the collected data in, for instance, the data storage 109, conforming to a data structure with specified data types defined by the context model.

In one embodiment, the behavior awareness module 105c and the context processing platform 103 interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

In another embodiment, the behavior awareness module 105c can operate independently of or without the presence of the context processing platform 103. In this way, the behavior awareness module 105c can perform all of the functions of the context processing platform 103 without transmitting any information to the platform 103, thereby decreasing any potential exposure of the context information, activity information and other interaction data to external entities. Accordingly, although various embodiments are described with respect to the context processing platform 103, it is contemplated that the functions of the platform 103 can also be performed by the behavior awareness module 105c or similar component of the system 100.

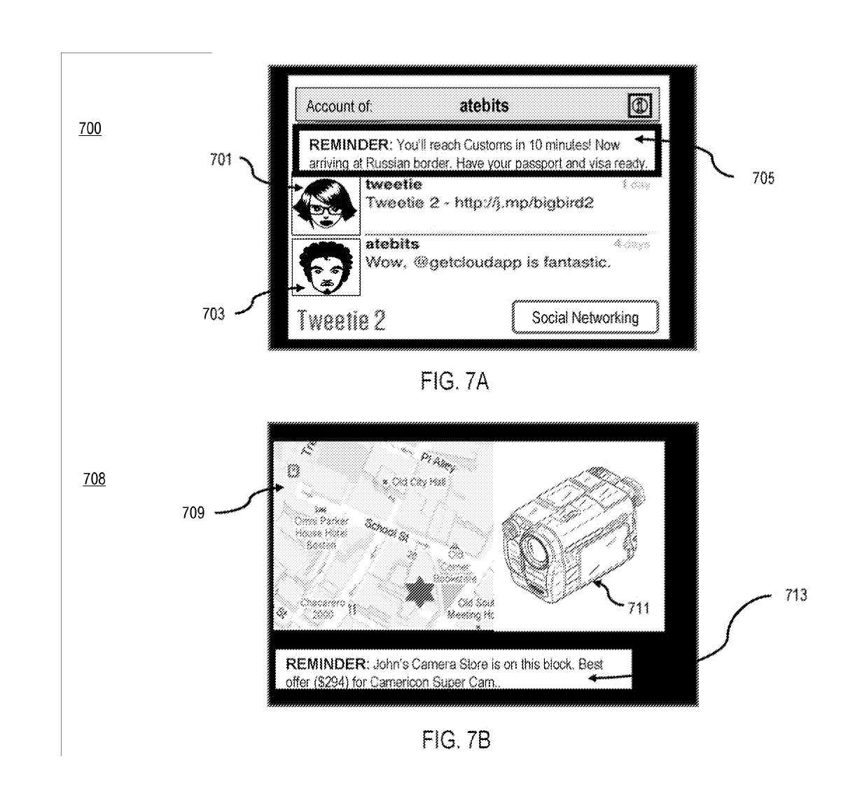

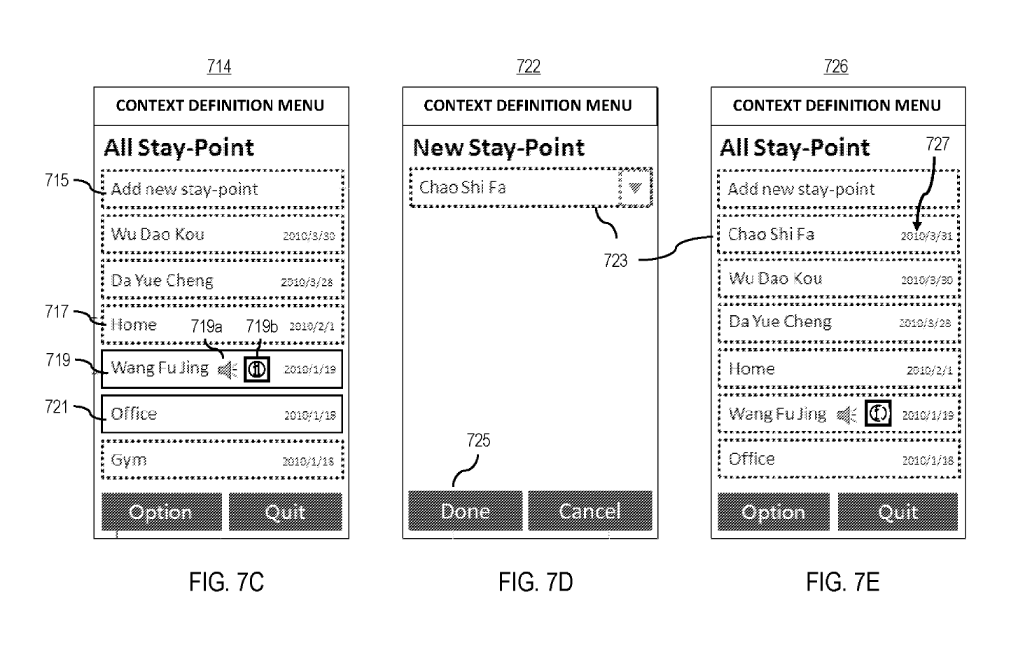

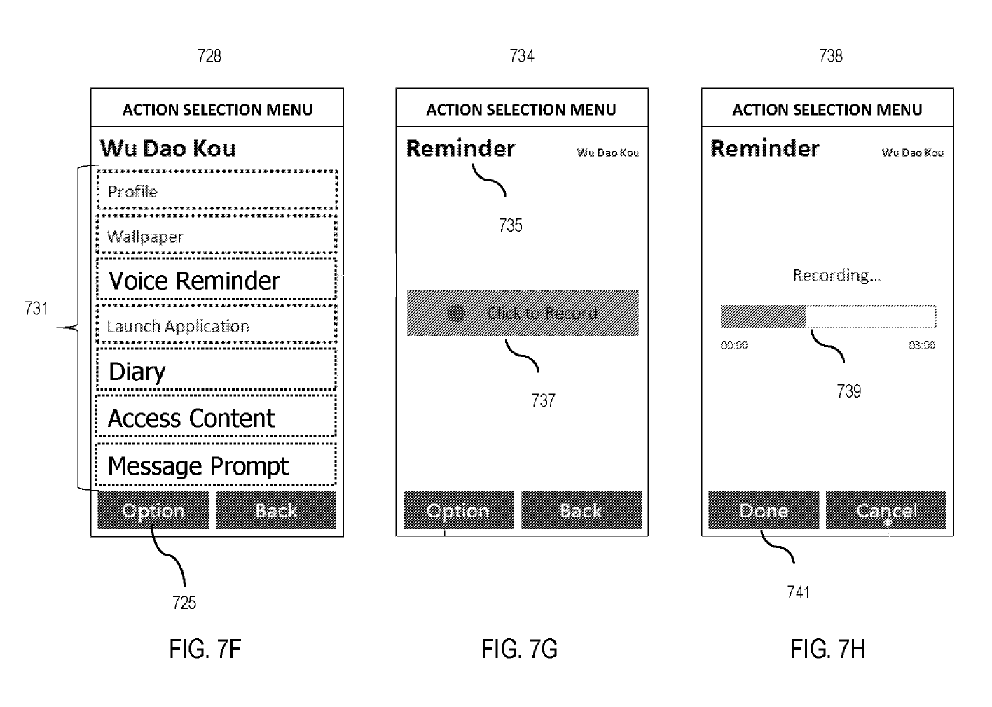

According to an exemplary embodiment, an action enabling module 105b manages the execution of reminders, alerts, user prompts and other signals to be generated or actions to be performed by the UE 101 in response to a determined user activity or context. As will be discussed further, the action enabling module 105b ensures execution of actions, including reminders, according to specified context conditions being met. The conditions may be met by the device upon which the action, such as a reminder, is to be executed or by another user or device, wherein the reminder is referred to as a collaborative context based reminder. The action enabling module 105b executes the necessary function calls, relative to the operating system, application programming interfaces and other control mechanisms of the UE 101 for rendering the reminder appropriately to the display, speaker or other embedded components of the device. In addition, the action enabling module 105b also presents a reminder selection interface that allows the user to select reminder types in association with specific contexts, events, combinations thereof or associated context criteria activities. The reminders may therefore be established from the perspective of a subscribing or publishing user of UE 101 accordingly. More regarding the exemplary interface is discussed in greater detail with respect to FIGS. 7F-7H.

According to an exemplary embodiment, a context coordination module 105d operates in connection with the action enabling module 105b to enable the sharing of contexts, events, context criteria for defining fulfillment of a particular context condition, or a combination thereof with other devices 101b-101n. By way of example, the context coordination module 105d allows for the creation of, sharing of and acceptance of collaborative context based reminders. A collaborative context based reminder defines a reminder that is executed upon fulfillment of one or more contexts, events or context conditions by one or more subscribing devices. By sharing, it is meant that the context coordination module 105d can publish such reminders with other devices, giving them an opportunity to subscribe to the particular context, event, context criteria, as specified in the request. Subscription to the context, event, context criteria as published is synonymous with acceptance of the collaborative context based reminder. The context criteria associated with a reminder may include, among other things, the particular user action that is to be performed by the subscribing UE 101b-101n, a specific location occurrence or reference associated with the user action, a specific device action to be performed, etc. As an example, if UEs 101b-101n receive and subsequently subscribe to a collaborative context based reminder as published by UE 101a, UEs 101b-101n can execute the specified reminder in response to the fulfillment of the specified context, event, context condition. The request, in addition to defining the context, event or conditions thereof, also specifies the type of reminder to be performed (e.g., alarm signal, message prompt).

Similarly, the context coordination module 105d enables the UEs 101 to subscribe to the collaborative context based reminder requests that are published by other UEs 101. Contexts, events, context criteria, etc., published by other UE 101b-101n as collaborative context based reminder requests, is presented to potential subscribing UEs 101. For example, if UE 101a receives a request, the request may specify at least the publisher UE 101b, perhaps the type of reminder to be invoked when the context criteria and conditions, and the context, event and associated context criteria required to be fulfilled by the UE 101a. In general, an exemplary subscription process may be carried out as follows: 1) receive a subscription notice indicating a collaborative context based reminder to be performed, the notice including details regarding the defined device or user context, the event and related context criteria from a user of other UE 101b-101n; 2) accept or reject the subscription request, wherein acceptance triggers performance of a probability analysis feature of the context coordination module 105d; 3) notify the publisher of acceptance or rejection of the subscription request, including indicating the specific device and/or user that accepted or rejected the request. With respect to the first step, the publishing user and/or user device is generally easily recognized by the user of the receiving UE 101a. However, in other instances, unrecognized users such as those within proximity of a potential subscriber may also publish a collaborative context based reminder, with the hope that another device user will comply.

In one embodiment, the context coordination module 105d also predicts the likelihood or probability of fulfillment of collaborative context based reminder; particularly the specified context, event or context criteria associated with the reminder to be carried out by the subscribing UE 101. In particular, the context coordination module 105d relies on a predetermined context model pertaining to the user of the subscribing UE 101 to predict the likelihood (e.g., to within a defined threshold) that the subscribed to context, event, etc. will happen within a certain time. This determination is based, at least in part, on the current sensed context of the subscribing user and their device as well as any historical context information pertaining to the context model for that UE 101. The context model for the subscribing UE 101 can be characterized as a sequence of contexts. For example, assume that the context model characterizes the user behavior or event patterns as a series of contexts or events as shown below: home->travel by bus->office->Lunch in restaurant->office->shuttle bus->shop->home-> . . . ,

Given this series of contexts, the contextual patterns can be represented as a context sequence. Furthermore, N-gram analysis may be employed as a probabilistic sequence modeling technique for learning the training set (i.e., series of contexts) which are applied for prediction of a next context given the n-length context history. In this way, it can be predicted whether subsequent contexts, events or user behavior is in alignment with the requested/published context, event, etc.

Still further, a context model based on planned or future user activities, such as based on user detected input captured by the activity capture module 105a, can be used to develop a deterministic context model. By deterministic, it is meant for example that a planned sequence of contexts or events pertaining to the user can be compared to the context, event and context criteria required for execution of the collaborative context based reminder. The extent to which the planned activities align with the subscription can be determined, so at ascertain the probability of fulfillment. As such, context modeling in this manner is relies on activity information as input. Exemplary inputs for modeling can include, but is not limited to, a date specified in a calendar application, an activity provided as a to do list entry, data entered into a sticky note editor, data saved to a contact manager, etc. Various other predictive modeling, data mining, vectorization, regression analysis and other techniques can also be employed accordingly for determining the probability.

Ultimately, if the probability is determined to be adequate, the reminder is queued for execution by the action enabling module 105b accordingly. When determined to be too low, the subscribing/receiving UEs 101 generates and transmits a notification message to the publishing/sending UE 101a, shown by way of example as: “Sorry, your reminder might not be triggered.” As a subsequent execution, the subscribing/receiving UE 101b-101n may also unsubscribe from the context reminder. Upon receipt of this message, the originating sender can directly contact the receiver if fulfillment of the collaborative context based reminder is deemed urgent. Alternatively, the originating sender can direct the collaborative context based reminder to others, such as in the case of a casual mission.

In one embodiment, a context determination module 105e determines or defines the current context associated with a user, a device such as UE 101a, other users or other devices such as UEs 101b-101n. Moreover, the context determination module 105e can detect context patterns (frequent users, places, things, activities associated with a given context—i.e., location, event, activity) that occur in the mobile user's historic context data, particularly as the information is organized according to a context model. The context determination module 105e analyzes the compiled (e.g., historic) context and activity information against present moment user and/or device context and activity information; enabling a means of validating current moment context or activity determination results with respect to the context model. Still further, the context determination module allows for the establishment of context tags, which are descriptors indicative of a particular context or event by way of name, location information, event identification and other data for specifying the context or event in question. The context tags may be manually defined by the user, via a context tagging interface as described in further detail with respect to FIGS. 7C-7H. Alternatively, the tags are defined automatically by the context determination module 105e in conjunction with data provided by the context processing platform 103. Automatic determination is based on historic data, a determined relevancy of a particular context and other factors.

For example, the context determination module 105e can receive historical data from the context processing platform 103 that reveals a frequent reference to a particular cellular identifier value (cell ID)—i.e., an identifier associated with a particular cellular site or wireless access point. In this example, cell-ID is used as one form of context related information in the form of location information, although other context information may be included aside from location (e.g., time, event, person). Having determined a frequent historical context, the context determination module 105e can leverage this data against current moment cell-ID values for the UE 101 to draw a conclusion about the current context in which the user and/or device is engaged.

Defining a context requires pairs of sensed rich context pattern (CP) data and human readable context tag (CT) data, e.g., context entry (CE)=[CP, CT]. In the example alluded to above, where the context information was cell-ID information, the context pattern is one or more such identifiers: CP=[CellID1, CellID2, . . . ]. The context tag associated with these identifiers, CT=[home]. The user can thus manually assign the context tag corresponding to the context patterns, or they can be assigned automatically or recommended by the context determination module 105e. A context based reminder will be triggered if the corresponding context is recognized either in the user's own UE 101a (my reminder) or the receivers' UE 101b-101n (collaborative context based reminder).

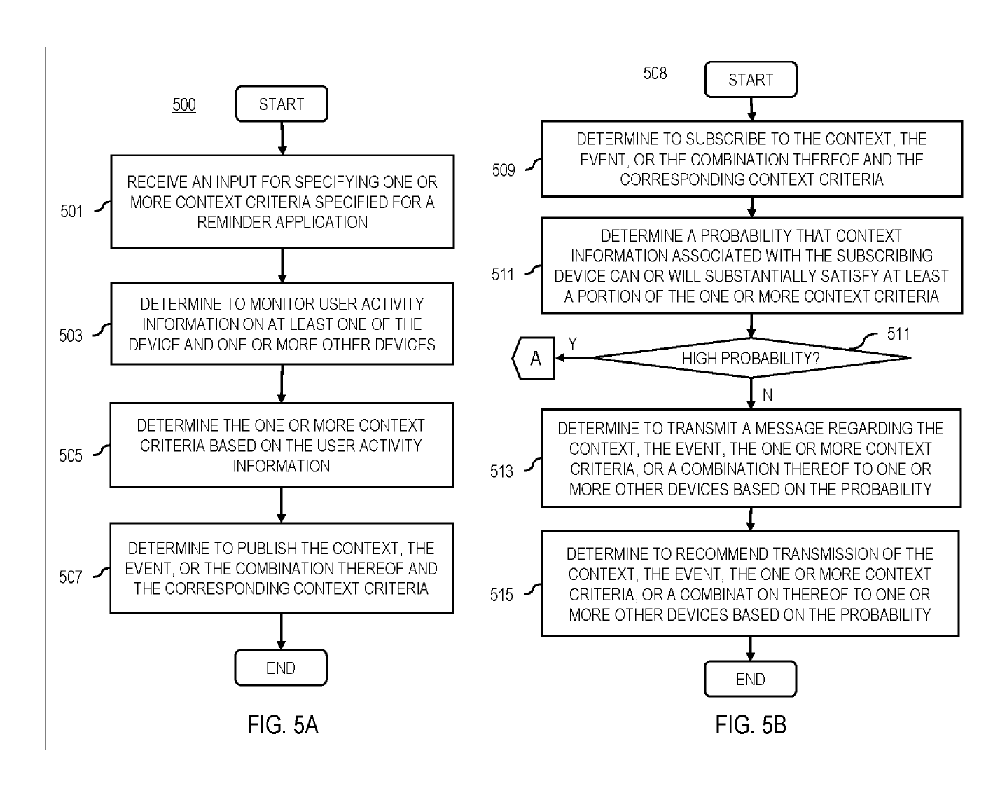

Other than manual definition, the context determination module 105e utilizes various techniques to determine if a context pattern reveals a context (e.g., particular point of interest) that is of significance. By way of example, the context determination module 105e uses CellIDs (or other location information) to identify the stay-points of a given user of UEs 101. A stay point signifies a location point where the user stays more than a certain time (e.g., 30 minutes), an indication that this is a significant place relative to the user and hence potentially indicative of a given context for the user and/or user's UE 101. Vectorization techniques may be applied to characterize the patterns for this particular stay point, such as represented by a vector of cell IDs with the corresponding probability factors. In further determining the significance and relevancy of a particular stay point so as to establish a context, the number of times the stay point has been visited can also be taken into consideration. If the context determination module 105e detects that a stay point has been visited a quite a few times in a certain period, the stay point is taken as a significant place and a context tagging suggestion is triggered. More regarding the context definition process is presented later on with respect to FIGS. 5A-5B.

By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 101 can support any type of interface to the user (such as “wearable” circuitry, etc.).

By way of example, the UE 101, the context processing platform 103 and the content platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model. By way of example, the UE 101 is operatively configured for enabling various online and network communication, including performing Internet searches, accessing network based intelligent information systems and the like.

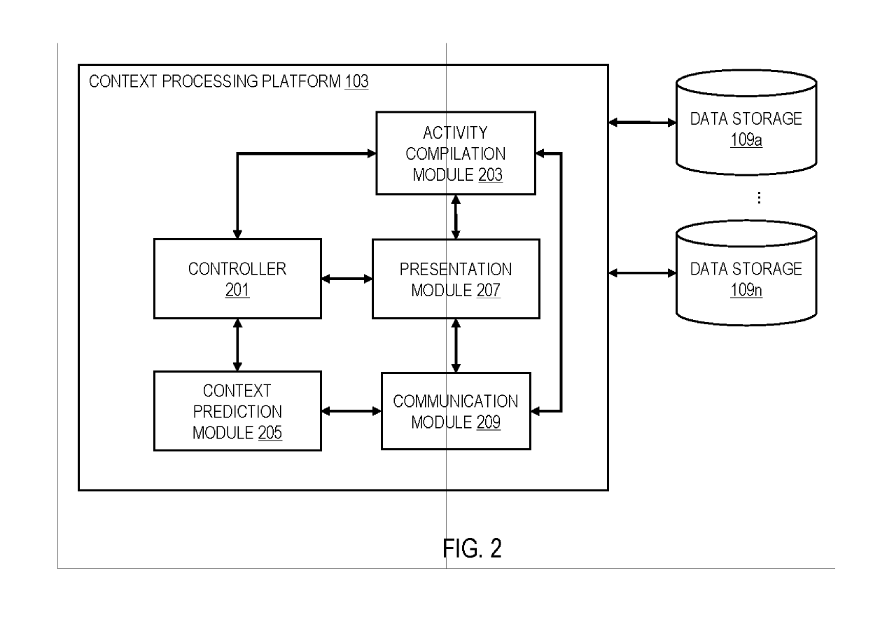

FIG. 2 is a diagram of a context processing platform, according to one embodiment. By way of example, the context processing platform 103 includes one or more components for maintaining context information as recorded or monitored by the UE 101 in association with a user defined context. It is contemplated that the functions of these components may be combined in one or more components or performed by other components of equivalent functionality. In one embodiment, the context processing platform 103 includes a controller 201, an input module 203, a computation module 205, a presentation module 207 and a communication module 209. The controller 201 oversees tasks performed by the components of the system, including facilitating data exchange and storage of context information through use of various data storage devices 109a-109n and regulation of its own interactions with other said components 203-207.

In one embodiment, the activity compilation module 203 compiles activity information, as provided by the activity capture module 105a into an activity file labeled according to the activity in question. As activity information is conveyed to the context processing platform 103 by the activity capture module 105a, the activity compilation module 203 analyzes the data to identify the most commonly used phrases, words or other items of content contained within. Alternatively, the analysis may include identifying which particular content is deemed most valuable to the user, based on time of viewing, bookmarks, annotations and notes taken, etc. The file is named accordingly based on this analysis. Furthermore, the file is organized by the activity compilation module 203 according to a defined context model or template and stored into data storage devices 109a-109n.

The context prediction module 205 performs computation and analysis of the activity information as compiled relative to a context module. By way of example, the context prediction module 205 formulates a prediction regarding user activities, and particularly, a context prediction corresponding to current monitored user activity. Results of this analysis, i.e., the prediction, are then shared with the context determination module 105e of the UE 101 for enabling its ability to determine a context. It is noted that the context prediction module 205 and context prediction modules 105e operate in conjunction to provide a means of context awareness. While the context determination module 105e operates locally on the UE 101a for interpreting a context of the user or UE 101, the context prediction module 205 accounts for context and activity pertaining to other devices 101b-101n for which the UE 101a interacts. This enables for a richer, more collaborative context sharing and processing experience for the all users and UEs. Respective UEs 101 are also provided the necessary intelligence, based on awareness of the relative contexts and activities, to facilitate the context subscription or publishing process.

In performing analysis, the context prediction module 205 executes one or more algorithms for processing context information. In addition, the context prediction module 205 determines relative context patterns pertaining to a given context model and appropriately correlates this to current activity information. For example, the computation module 205 may receive acquired activity information as compiled by the activity compilation module 203, parse it to identify specific data elements of interest, then compare said elements against a rules base associated with a particular context. This rules base may be defined according to one or more context criteria as formulated during the collaborative context based reminder configuration process.

Additional tasks performed by the context prediction module 205 may also include data modeling generation and context model training. Specifically, the computation module 205 may enable generation of and maintenance of an initial context model for a given context. This may include establishing a name for a context model relative to a user desired context to be defined (e.g., “Playing Golf”), processing user defined input data types, associating one or more sensors 111 for providing said inputs, correlating one or more output data types, conditional settings, etc. The initial context model can be structured, at least in part, based on an initial “labeled” data set. In other instances, it can be based on “historical” data interactions. The user may interact with and influence the context processing platform 103 to engage a user defined context of their liking by way of a data exchange or upload process, or alternatively, through usage of the device input mechanisms such as a touch screen, keyboard or the like. Any well known means for generating a context model are useable with respect to the embodiments presented herein.

In one embodiment, the presentation module 207 facilitates presentment of a user interface for allowing an administrator or other authorized user to access the context processing platform. By way of example, the user can access various server functions and/or perform actions related to the various modules, including but not limited to, establishing, uploading or defining a context model and related data input types and classifications, selection by the user of a given context to invoke, enabling training information to be provided for enhancing context prediction, etc.

In another embodiment, the various protocols, data sharing techniques, and the like required for enabling collaborative execution between UEs 101, 101b-101n is provided by way of a communication module 209. The communication module 209 also facilitates execution over the communication network 105. In addition to the transmission of pertinent information, such as predictions rendered by the context prediction module 205, the communication module also facilitates the exchange of valuable context information, activity information and other data with associated UEs 101.

The UE 101 may also be connected to storage media such as the data storage media 109a-109n such that the context processing platform 103 can access or store context information accordingly. If the data storage media 109a-109n is not local to the platform 103, then storage media 109a-109n may be accessed via the communication network 105. The UE 101 may also be connected to the content platform 113 via the communication network 105 to access content 115a-115n that is useful for subsequent recall. As mentioned before, the functionality described in the preceding paragraphs with respect to the context processing platform 103 applies equally to the behavior awareness module 105c operable on a device. Different implementations may be applied to fit different requirements.

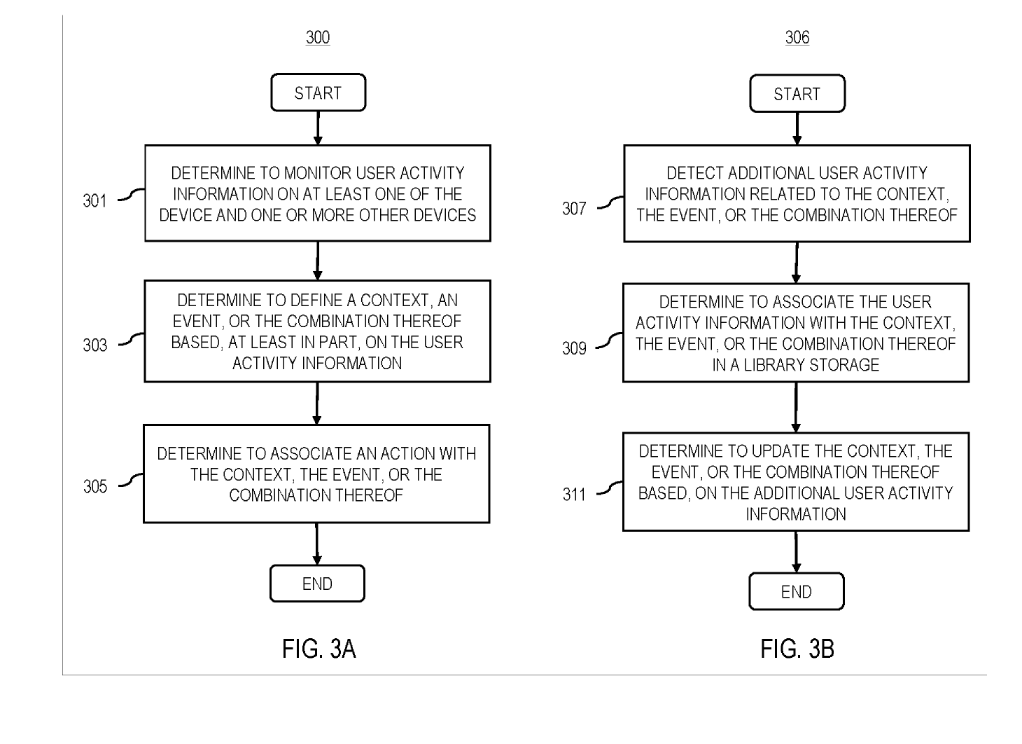

FIGS. 3A and 3B are flowcharts of a process for determining context information associated with a device, a user of a device, or a combination thereof, according to one embodiment. In step 201 of the process 300, it is determined to monitor user activity information on at least one of the device and one or more other devices. By way of example with respect to FIG. 1, activity information pertaining to UEs 101a and 101b-101n would be processed by respective devices in connection with the context processing platform 103. In a next step 303, it is determined to define a context, an event, or a combination thereof based, at least in part, on the user activity information. This is done in part by organizing the user activity information captured by the activity capture module 105a according to one or more context models or templates. The context processing platform 103 then operates in connection with the context determination module of the UE 101 to define the current moment context, event, etc. In yet another step 305, it is determined to associate an action as performed by the device at present with the context, the event or the combination thereof.

In a step 307 of the process 306 of FIG. 3B, additional user activity information related to a previously defined context, event or combination thereof is detected. For example, when an action engaged by a user or user device is determined to be associated with a particular context defined as “Honeymoon Plans,” any additional user or device activity associated with this context needs to be monitored and associated as well. Hence, in a step 309, it is determined to associate the user activity information with the context, the event, or the combination thereof in library storage 109, such as maintained by the context processing platform 103. In yet another step 311, it is determined to update the context, the event or the combination thereof based on the additional user activity information.

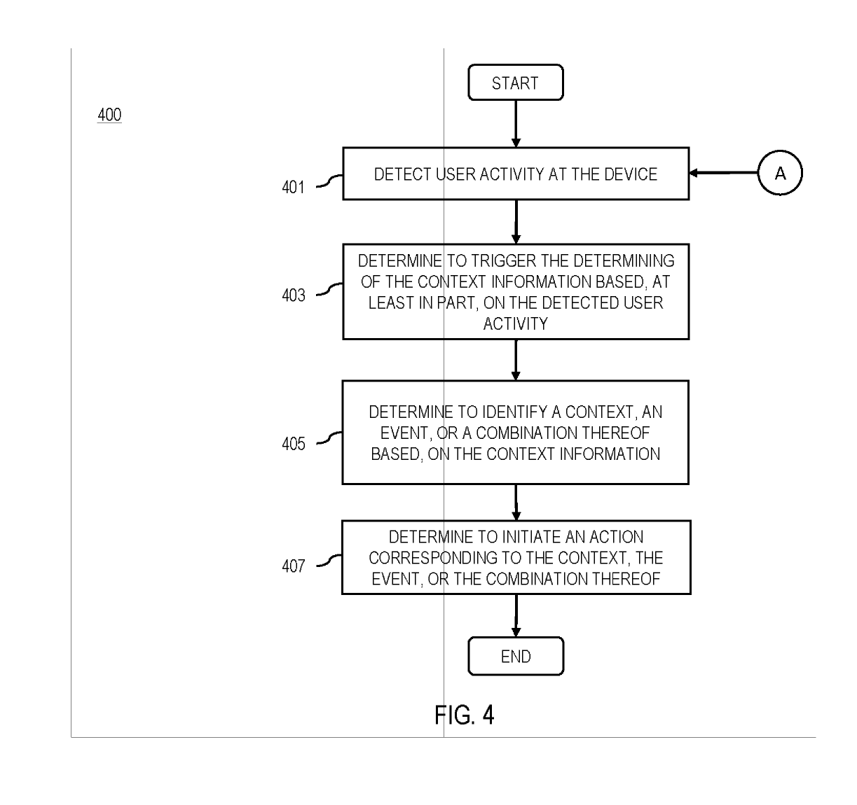

FIG. 4 is a flowchart of a process for determining to initiate an action corresponding to a determined context, event or combination thereof, according to one embodiment. In a step 401 of the process 400, user activity is detected by a device, such as by way of the activity capture module 105a. In a next step 403, it is determined to trigger a process for determining context information that pertains to the present user activity. The process 300 further includes performance of step 405, where it is determined to identify a context, an event or a combination thereof based on the context information. In yet another step 407, it is determined to initiate an action corresponding to the context, the event or the combination thereof. The action may correspond to a device action, such as a reminder or recalling of content for display to the device interface.

FIGS. 5A and 5B are flowcharts of a process for associating a context, event and corresponding context criteria with one or more devices for enabling a device action, according to one embodiment. In a step 501 of the process 500, an input for specifying one or more context criteria specified for a reminder application is received. The criteria may include condition and/or rules for defining the execution of the reminders respective to a determined context, event, sequence of contexts, sequence of events, or a combination thereof. In a next step 503, it is determined to monitor user activity information on at least one of the device and one or more other devices. Monitoring activity across devices, such as via the context processing platform, facilitates collaborative context based reminder execution. In another step 505, the one or more context criteria are determined based on the user activity information. Still further, in another step 507, it is determined to publish the context, the event or the combination thereof and the corresponding context criteria. By way of example, this corresponds to publishing of a context based reminder, for enabling one or more subscribers to accept the reminder.

In FIG. 5B, the process for subscribing to a published context based reminder is presented. In Step 509, one or more other devices determine to subscribe to the context, the event or the combination thereof and the corresponding context criteria. In a next step 511, a probability that context information associated with the subscribing device(s) can or will substantially satisfy at least a portion of the one or more context criteria is determined. When a high probability is determined, such as to within a predetermined threshold, the steps corresponding to off page reference A to FIG. 4, are performed.

When a low probability is determined however, in step 513 it is determined to transmit a message regarding the context, the event, the one or more context criteria, or a combination thereof to one or more other devices based on the probability. The message may suggest to the sending device that the likelihood of fulfillment of the required collaborative context based reminder could not be fulfilled. In yet another step 515, it is determined to recommend transmission of the context, the event, the one or more context criteria or a combination thereof to one or more devices based on the probability. The transfer process may be performed with select user devices, may include republishing of the collaborative context based reminder, or can be restricted to only those devices having a high likelihood of fulfillment of the request.

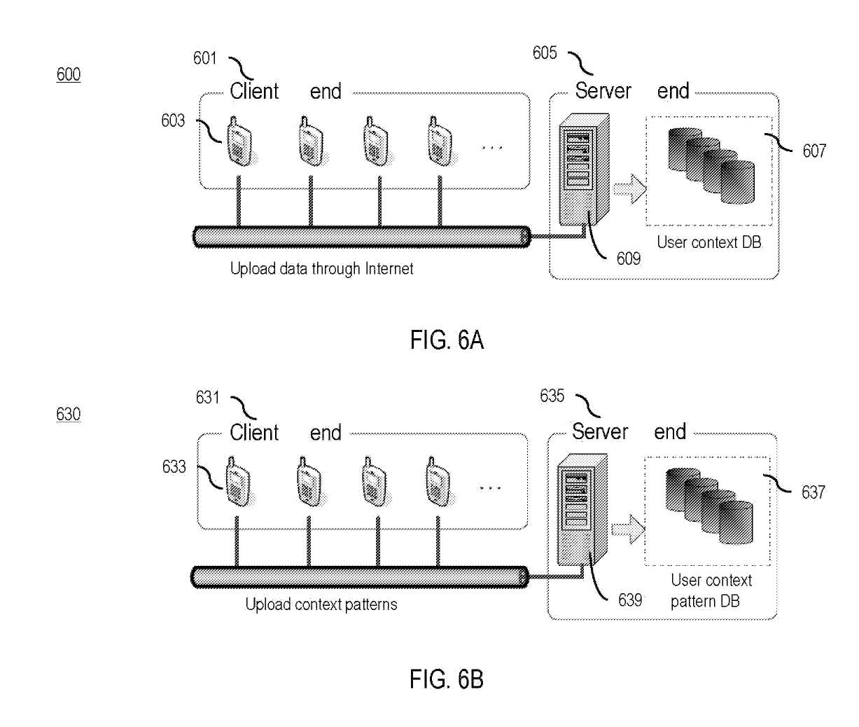

FIGS. 6A and 6B are diagrams of interactions between a client and a server utilized in data mining included in the processes of FIGS. 4A, 4B and 5, according to various embodiments. FIG. 6A shows that data such as context records retrieved at the client end 601 from mobile devices 603 (e.g., UEs 101a-101n), may be uploaded to the server end 605 through the Internet (e.g., communication network 105). In one embodiment, the server end 605 may include the behavior platform 103 and/or the service platform 113. At the server end 605, the uploaded data is stored in the user context database 607. This embodiment is advantageous in that the mobile devices 603 can reduce their computational burdens associated with the data mining to the server 609. It is noted that the server 609 generally has more processing power and related resources (e.g., bandwidth, memory, etc.) than the mobile devices to handle this type of computation.

Alternatively, as shown in FIG. 6B, the data retrieved by the mobile devices 633 at the client end 631 may be stored at storage media (not shown) of the respective mobile devices 633. The mobile devices 633 may then locally perform the computations for determining, for instance, the context patterns from the data. Then, the result of the computation (e.g., the context patterns) may be uploaded to the server end 635 including a server 639 and user context pattern database 637. This embodiment is advantageous in that the data is kept within the respective mobile devices 633, and is not uploaded to other devices or servers without the user's permission. Thus, this embodiment in FIG. 5B provides a higher level of privacy protection. In addition, for both embodiments in FIGS. 5A and 5B, the user of the mobile device may configure a privacy setting to determine whether any data retrieved from the mobile device can be sent to the server end 635. Further, although not shown, much of the analysis of the behavior pattern according to this invention may be performed within the mobile device 633 even when the mobile device 633 is not connected to the server 639. As long as the mobile device 633 has the data and sufficient processing power to analyze the data, then the server 639 may not be required to perform the analysis.

FIGS. 7A-7H are diagrams of user interfaces of a device utilized in the processes of FIGS. 3A, 3B, 4, 5A and 5B, according to various embodiments. By way of example, FIGS. 7A and 7B present a device user interface for rendering a device action in one or two forms: 1) a reminder based action; 2) a recall action for rendering historical search information to the interface of the user device. Device interface 700 depicts a social networking interaction between a first and second user, represented by respected avatars 701 and 703 accordingly. If the second user 703 of the device is travelling while engaging in the social networking interaction with the other first user 701, context based reminders are presented to the device interface 700 when specific context criteria is determined to be fulfilled. In this example, the reminder 705 is presented in the form of a message prompt for the user to read, the message detailing content 115a that is appropriate for the context in question. Depending on implementation preferences, the reminders may appear atop the current running application or attempt to find suitable whitespace for presenting in as least obtrusive a manner as possible.

In FIG. 7B, a user engages a map application 709 via their device interface 708 in order to identify a store that sells a video camera that the user researched. As the user approaches the destination, the device recalls historical information pertaining to the video camera, i.e., image data 711 representative of the device the user wishes to purchase. The user is also presented with a reminder 713 containing other useful, historical information that is relevant to the user's current activity or context.

With reference now to FIGS. 7C-7E, an exemplary user interface of a mobile device for enabling the defining of context data and associated device actions is shown, according to various embodiments. It is noted that the exemplary user interfaces are rendered by way of the context determination module 105e in conjunction with the appropriate display capabilities of the user equipment in question. According to an exemplary embodiment, in FIG. 7C the interface 714 is a context definition menu that enables the user see all of the current context tags defined as stay points (corresponding to a location), such as stay point 719 which is tagged as “Wang Fu Jing” corresponding to a location/coordinates in Beijing, China. As indicated by the icon 719a, this stay point has already been associated with a particular reminder in the form of an alarm signal. As such, when the UE 101 is determined to arrive at or proximate this location, the alarm signal will sound accordingly. In addition, another icon 719b indicates that fulfillment of the context will result in a display of certain information to the user accordingly, such as a display of content related to shopping activities at Wang Fu Jing.

Also, from the context definition menu 714, the user can also select from a pre-determined listing of context tags for the purposes of defining a new stay point, option to create a custom tag 715 for tagging a new location based context as a stay point. When the user selects this option 715, a new stay point entry screen 722 of the context definition menu is shown as in FIG. 7D, according to an exemplary embodiment. In this way, when the user is in a certain place they want the context processing platform 103 to remember, the location can be tagged appropriately and thus maintained as context information. For example, when the user visits a local supermarket chain in China, they may assign the context tag 723 with the store name “Chao Shi Fa” or any other descriptor of their liking. Alternatively, the context tag can be recommended automatically by the context determination module 105e, such as based on the determined cell-ID pattern information associated with the proximate user location as compiled (historical) and at present, known to correspond to a particular location name. The context may also be tagged based on the most prominent or frequently used items, phrases or words associated with a search activity or returned as content 115a-115n. Upon completion, the user can press the “Done” button 725. According to an exemplary embodiment, this results in the newly added stay point being presented in the primary listing of context tags of the context definition menu 726 of FIG. 2C with the appropriate date of entry 727 indicated.

Having defined automatically and/or manually the context, i.e., Wu Dao Kou, the context can be further associated with a particular device action, such as a reminder execution. According to an exemplary embodiment, FIG. 7F presents an action selection menu 728 that allows the user to select action types in association with specific contexts, events, combinations thereof or associated context criteria. The interface may be accessed, for example, through activation of an “Option” button 729. Actions available for selection in this example, include but are not limited to, a profile driven action, a wallpaper change action, a voice reminder, an application launch, a diary recordation action, a content access action and a message prompted reminder.

In FIG. 7G, the display resulting from user selection of a device action is shown, according to an exemplary embodiment. In this example, the selected action is a voice reminder 735 for enabling the user to record sound content in association with the Wu Dao Kou context. The user is prompted to click the record button 737 to being the voice recording process. FIG. 7H presents an exemplary 736 depiction of the recording process, according to an embodiment. An indicator is provided for representing the length of time of the recording. Once the recording is complete, the user can select the “Done” button to signify completion of the action selection process. It is noted that the user may assign multiple reminders and/or actions to a defined context. Furthermore, the user may also invoke various options for customizing and managing the reminder execution process. For example, by way of the “Option” button of FIG. 7F, the user may adapt establish recurrence settings for the reminder, manipulate the duration of the reminder, establish and specify any associated context criteria or conditions, etc. Moreover, the action execution module 105b provides a configuration interface (not shown) for enabling users to arrange, sequence and time actions to be executed relative to a given context. Still further, the configuration interface allows for the linking of contexts, per an established context template or model, for arranging a sequence of actions across contexts. By way of example, the Wu Dao Kou context may be linked to the Wang Fu Jing and Chao Shi Fa context as a combined context tagged as “My Trip to China,” wherein the combined context is associated with and set to perform the various actions of the linked contexts in response to their respective context conditions being fulfilled.

While the above described context definition examples are presented from the perspective of location based context information, the same process applies equally to other types of context information. For example, if the determined context information corresponds to a particular user or user device, defining the user or device context would be similarly discerned from the historical and present moment context information and activity information to generate a context tag for that context, i.e., Mom, Levie Ball, Susan, Little Sister, My Supervisor, Pekka's Phone or any other descriptor as manually established or recommended by the system. Consequently, reminders may be triggered conditionally based on the perceived interaction with or proximity to these users and/or their devices. Examples include a reminder to suggest to your supervisor a new project proposal at a team meeting, a reminder for your sister to return the money she borrowed from you next time she's at your house (collaborative context based reminder), etc. As yet another example, if the determined context information corresponds to a particular user activity, the context tag for defining the activity may be Video Games, Reading, Fooding, Martial Arts, Meditation. A reminder associated with the defined context may include, for example, launching of an application for turning out the lights when the user enters a specific meditation room of their home, a recall of menus to you and your dinner companion's device displays when traveling to the next food outing, etc.

The processes described herein for initiating a device action in response to determining context information associated with a device, a user of the device, or a combination thereof may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

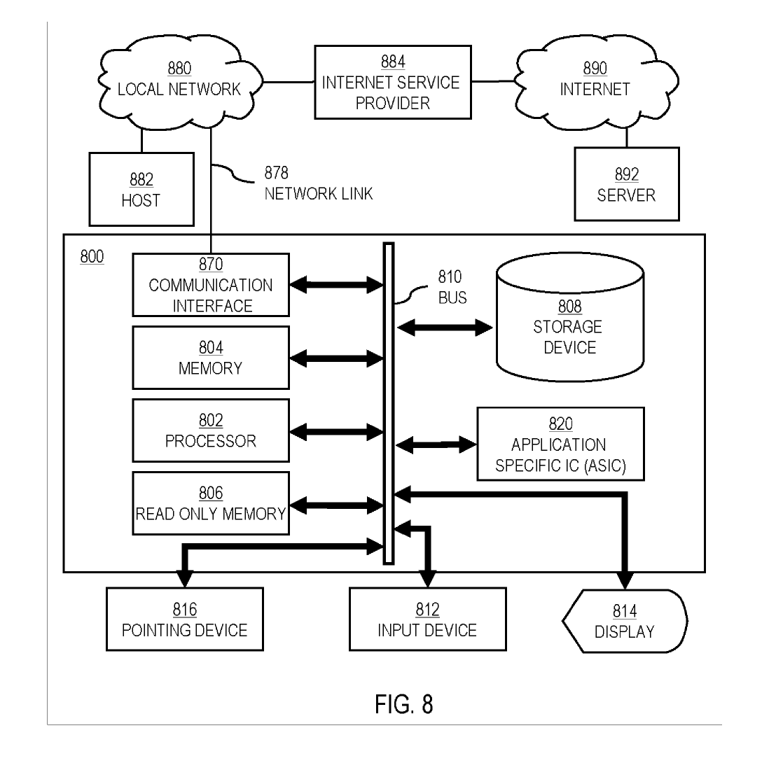

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to initiate a device action in response to determining context information associated with a device, a user of the device, or a combination thereof as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of initiating a device action in response to determining context information associated with a device, a user of the device, or a combination thereof.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to initiating a device action in response to determining context information associated with a device, a user of the device, or a combination thereof. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for initiating a device action in response to determining context information associated with a device, a user of the device, or a combination thereof. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for initiating a device action in response to determining context information associated with a device, a user of the device, or a combination thereof, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for initiating a device action in response to determining context information associated with a device, a user of the device, or a combination thereof to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

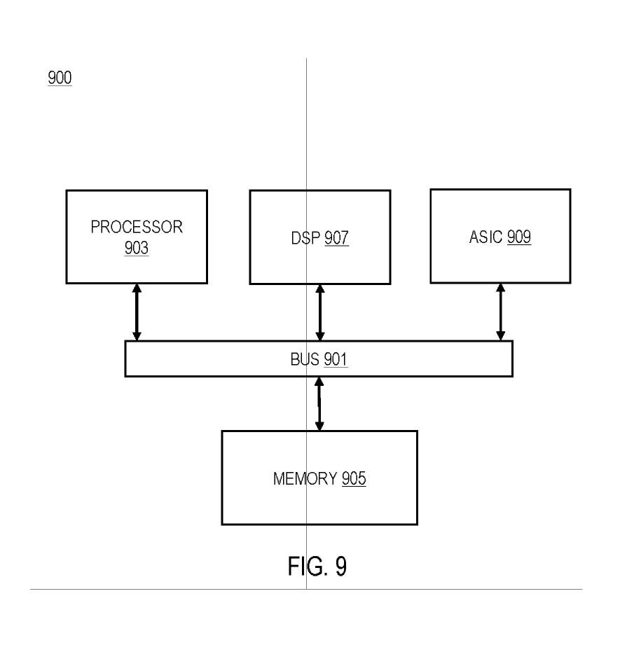

FIG. 9 illustrates a chip set or chip 900 upon which an embodiment of the invention may be implemented. Chip set 900 is programmed to associate user, object or device context information with a user defined context model representative of a real-world context as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of services. Chip set or chip 900, or a portion thereof, constitutes a means for performing one or more steps of initiating a device action in response to determining context information associated with a device, a user of the device, or a combination thereof.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to initiate a device action in response to determining context information associated with a device, a user of the device, or a combination thereof. The memory 905 also stores the data associated with or generated by the execution of the inventive steps.

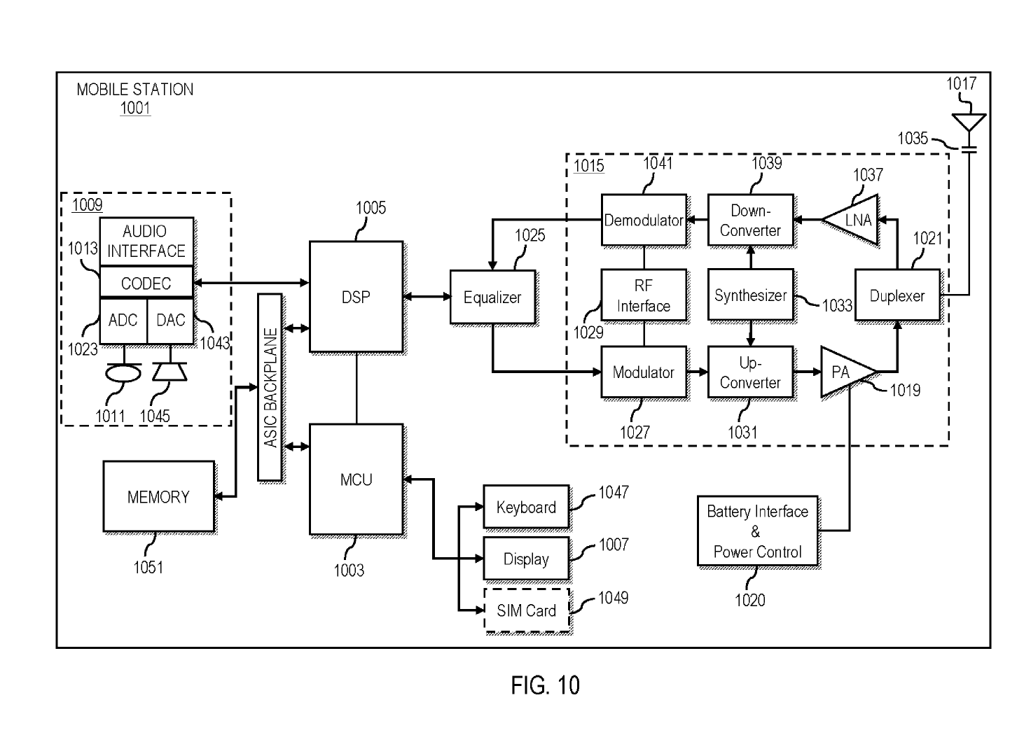

FIG. 10 is a diagram of exemplary components of a mobile terminal (e.g., handset) for communications, which is capable of operating in the system of FIG. 1, according to one embodiment. In some embodiments, mobile terminal 1000, or a portion thereof, constitutes a means for performing one or more steps of initiating a device action in response to determining context information associated with a device, a user of the device, or a combination thereof. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of initiating a device action in response to determining context information associated with a device, a user of the device, or a combination thereof. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to associate user, object or device context information with a user defined context model representative of a real-world context. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-48. (canceled)

49. A method comprising:
determining to monitor user activity information on at least one of a device and one or more other devices;
determining to define a context, an event, or a combination thereof based, at least in part, on the user activity information; and
determining to associate an action with the context, the event, or the combination thereof.

50. A method of claim 49, further comprising:
determining context information associated with the device, a user of the device, the one or more other devices, one or more other users of the one or more other devices, or a combination thereof;
determining to identify the context, the event, or a combination thereof based, at least in part, on the context information; and
determining to initiate the action corresponding to the context, the event, or the combination thereof.

51. A method of claim 50, further comprising:
determining to organize the user activity information according to one or more templates,
wherein the defining of the context, the event, or the combination thereof is based, at least in part, on the one or more templates.

52. A method of claim 49, further comprising:
determining to generate an identifier of the context, the event, or the combination thereof based, at least in part, on the user activity information.

53. A method of claim 52, wherein the identifier is generated based, at least in part, on the relative frequency of one or more items occurring in the user activity information.

54. A method of claim 49, further comprising:
detecting additional user activity information related to the context, the event, or the combination thereof; and
determining to update the context, the event, or the combination thereof based, at least in part, on the additional user activity information.

55. A method of claim 49, further comprising:
determining to associate the user activity information with the context, the event, or the combination thereof in a library storage.

56. A method of claim 49, wherein the action comprises:
determining to present at least a part of the user activity information, related information, or a combination thereof.

57. A method of claim 49, further comprising:
detecting user activity at the device; and
determining to trigger the determining of the context information based, at least in part, on the detected user activity.

58. An apparatus comprising:
at least one processor; and
at least one memory including computer program code for one or more programs,
the at least one memory and the computer program code configured to, with the at least one processor, cause the apparatus to perform at least the following,
determine to monitor user activity information on at least one of a device and one or more other devices;
determine to define a context, an event, or a combination thereof based, at least in part, on the user activity information; and
determine to associate an action with the context, the event, or the combination thereof.

59. An apparatus of claim 58, wherein the apparatus is further caused to:
determine context information associated with the device, a user of the device, the one or more other devices, one or more other users of the one or more other devices, or a combination thereof;
determine to identify the context, the event, or a combination thereof based, at least in part, on the context information; and
determine to initiate the action corresponding to the context, the event, or the combination thereof.

60. An apparatus of claim 59, wherein the apparatus is further caused to:
determine to organize the user activity information according to one or more templates,
wherein the defining of the context, the event, or the combination thereof is based, at least in part, on the one or more templates.

61. An apparatus of claim 58, wherein the apparatus is further caused to:
determine to generate an identifier of the context, the event, or the combination thereof based, at least in part, on the user activity information.

62. An apparatus of claim 61, wherein the identifier is generated based, at least in part, on the relative frequency of one or more items occurring in the user activity information.

63. An apparatus of claim 58, wherein the apparatus is further caused to:
detect additional user activity information related to the context, the event, or the combination thereof; and
determine to update the context, the event, or the combination thereof based, at least in part, on the additional user activity information.

64. An apparatus of claim 58, wherein the apparatus is further caused to determine to associate the user activity information with the context, the event, or the combination thereof in a library storage.

65. An apparatus of claim 58, wherein the action further causes the apparatus to:
determine to present at least a part of the user activity information, related information, or a combination thereof.

66. An apparatus of claim 58, wherein the apparatus is further caused to:
detect user activity at the device; and
determine to trigger the determining of the context information based, at least in part, on the detected user activity.

67. A computer program product including one or more sequences of one or more instructions which, when executed by one or more processors, cause an apparatus to at least perform the steps of:
determining to monitor user activity information on at least one of a device and one or more other devices;
determining to define a context, an event, or a combination thereof based, at least in part, on the user activity information; and
determining to associate an action with the context, the event, or the combination thereof.

68. A computer program product of claim 67, further comprising:
determining context information associated with the device, a user of the device, the one or more other devices, one or more other users of the one or more other devices, or a combination thereof;
determining to identify the context, the event, or a combination thereof based, at least in part, on the context information; and
determining to initiate the action corresponding to the context, the event, or the combination thereof.
